(19) United States
(12) Patent Application Publication
(10) Pub. No.: US 2022/0188896 A1
(43) Pub. Date: Jun. 16, 2022

(54) SYSTEMS AND METHODS FOR ACQUISITION GUIDANCE ALERTS BASED ON BIOMETRIC CHARACTERISTICS

(71) Applicant: Capital One Services, LLC, McLean, VA (US)

(72) Inventor: William PRIOR, Richmond, VA (US)

(73) Assignee: Capital One Services, LLC, McLean, VA (US)

(21) Appl. No.: 17/122,511

(22) Filed: Dec. 15, 2020

(51) Int. Cl. G06Q 30/06

(52) U.S. Cl. CPC G06Q 30/0631

(57) ABSTRACT

A computer-implemented method that includes for providing acquisition guidance alerts that includes receiving a signal from a user device indicative of a biometric characteristic of a user. The biometric characteristic is detected by the user device. The method includes determining the biometric characteristic exceeds a predetermined threshold. The predetermined threshold defines a first state of the user. The method further includes transmitting an alert to the user device with guidance information on conducting future acquisitions during the first state.

### TECHNICAL FIELD

Various embodiments of the present disclosure relate generally to a system for providing acquisition guidance, and relate particularly to methods and systems for generating alerts for influencing product acquisitions based on biometric characteristics of a user.

### BACKGROUND

A behavior, judgment, and/or action of a consumer may be easily influenced by a current emotional, mental, or physical state. For example, a consumer may conduct one or more product acquisitions (e.g., purchases) that may be counter to the consumer's financial health during certain emotional, mental, or physical states. In such instances, a consumer may momentarily overlook or fail to recall prudent spending habits while in an influenced state. Despite experiencing heightened physical characteristics (e.g., pulse, aspiration, etc.) during certain emotional, mental, or physical states, a consumer may fail to appreciate a current influenced state, resulting in an increased likelihood of performing purchases that the consumer may later deem to be superfluous, imprudent, and/or otherwise not in their own best interests.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for generating acquisition guidance alerts. Each of the examples disclosed herein may include one or more of the features described in connection with any of the other disclosed examples.

In one example, a computer-implemented method for providing acquisition guidance alerts may include: receiving a signal from a user device indicative of a biometric characteristic of a user, wherein the biometric characteristic is detected by the user device; determining the biometric characteristic exceeds a predetermined threshold, wherein the predetermined threshold defines a first state of the user; and transmitting an alert to the user device with guidance information on conducting future acquisitions during the first state.

In another example, a computer-implemented method for providing guidance alerts may include: accessing biometric data of a user from a user device, wherein the biometric data is indicative of a current state of the user; accessing acquisition data of the user from a data repository, wherein the acquisition data corresponds to the current state of the user; training a machine learning model using the biometric data and the acquisition data to predict an occurrence of an acquisition by the user during the current state; and generating an alert using the trained machine learning model by: receiving a signal from the user device indicative of a biometric characteristic of the user; determining the biometric characteristic correlates to the user conducting future acquisitions during the current state; and transmitting the alert to the user device with guidance information to prevent the user from conducting the future acquisitions during the current state.

In a further example, a system may include a processor, and a memory storing instructions that, when executed by the processor, causes the processor to perform operations including: receiving a signal from a user device indicative of a biometric characteristic of a user, wherein the biometric characteristic is detected and measured by the user device; determining the biometric characteristic exceeds a predetermined threshold, wherein the predetermined threshold defines an impulsive state of the user; and transmitting an alert to the user device with guidance information for the user on conducting future acquisitions during the impulsive state.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary client-server environment that may be utilized according to aspects of the present disclosure.

FIG. 2 depicts an exemplary process for transmitting an acquisition guidance alert to a user device.

FIG. 3 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

In general, the present disclosure provides methods and systems for generating and transmitting acquisition alerts to a user device based on determining a biometric characteristic of the user exceeds a predetermined threshold indicating a current state of the user. The acquisition alerts may serve as a wellness tool that may provide users with a notification directed at encouraging responsible, financial decision-making. As will be discussed in greater detail herein, existing techniques may be improved with the methods and systems of the present disclosure.

Users seeking to minimize instances of erratic, impulsive spending or uncharacteristic purchases during periods of increased stress or anxiety may require proactive assistance in identifying the increased likelihood of such behavior when in an influenced state. Users may be unaware of their momentary propensity to conduct transactions that may be later deemed by the user to be unnecessary given a failure to recognize the user's current influenced state. Accordingly, a need exists to provide a real-time ability to generate and transmit alerts to a user with guidance information on conducting future acquisitions when in an influenced state.

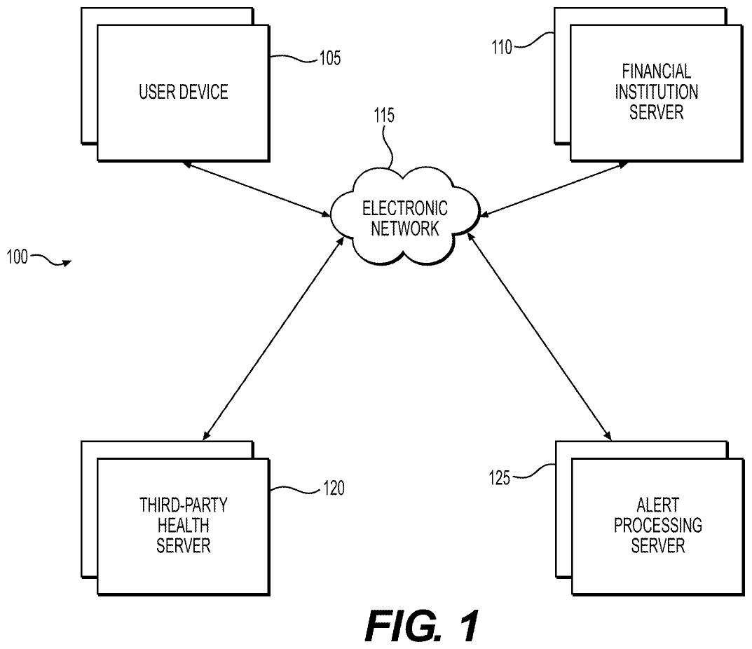

FIG. 1 depicts an exemplary client-server environment that may be utilized with techniques presented herein. For example, the environment may include a system 100 with one or more user devices 105, one or more financial institution servers 110, one or more third-party health servers 120, and an alert processing server 125. The one or more components of system 100 may communicate with one another across an electronic network 115, and in any arrangement.

It should be appreciated that system 100 may include a plurality of users, each of which may include or otherwise be associated with at least one user device 105. User device 105 may include various suitable apparatuses, including but not limited to, a mobile device, a computer, a wearable device (e.g., a watch, a smartwatch, an activity tracker device, a bracelet, a necklace, an armband, glasses, a hat, a shirt, a pant, etc.), and the like. User device 105 may be configured to measure one or more biometric characteristics of a user of user device 105, and transmit a signal indicative of the biometric characteristics to one or more of the components of system 100 (e.g., third-party health server 120, alert processing server 125, and the like). As described in greater detail herein, the signal from user device 105 may be automatically transmitted to the one or more components of system 100 via network 115 at periodic intervals in response to user device 105 detecting the biometric characteristic. In this instance, the one or more components of system 100 may determine whether the biometric characteristic exceeds a predetermined threshold. In other embodiments, the signal from user device 105 may be transmitted to the one or more components of system 100 via network 115 in response to the biometric characteristic exceeding a predetermined threshold.

In the example, user device 105 may be configured to detect and measure a plurality of biometric characteristics of the user, such as, for example, a pulse (heart) rate, a galvanic skin response, a voice cadence, a bodily temperature, a facial contour, electrodermal activity (EDA), and more. User device 105 may be in contact with, or positioned adjacent to, a user such that user device 105 may periodically or continuously detect the plurality of biometric characteristics. In some embodiments, user device 105 may include one or more sensors (e.g., infrared sensor, light source, etc.) configured to detect the plurality of biometric characteristics. In other embodiments, user device 105 may include, or be communicatively coupled with, one or more devices configured to detect the biometric characteristics. For example, user device 105 may include an imaging device operable to capture images of the user.

The user may be a customer of one or more financial institutions and may have one or more consumer accounts with said financial institution(s). In this instance, the one or more consumer accounts may be stored on (or otherwise associated with) financial institution server 110. The user may conduct one or more transactions with the consumer account(s), such as, for example, purchasing a product, a good, or a service from one or more merchants, retailers, and the like. Financial institution server 110 may include a data repository for storing historical financial data, such as, for example, acquisition (purchase) data. In other embodiments, it should be appreciated that financial institution server 110 may be a separate component from the data repository storing the financial data.

One or more user devices 105 may include a third-party software installed thereon for measuring one or more of the plurality of biometric characteristics described above. The third-party software may include, but is not limited to, an electronic application (e.g., a mobile internet application, a text messaging application, an e-commerce application, a social media application, or the like), an internet browser extension, or a website page. The third-party software on user device 105 may include programmable instructions that cause user device 105 to communicate with third-party health server 120.

For example, the third-party software on user device 105 may be operable to perform periodic (e.g., second(s), minute(s), hour(s), day(s), week(s), etc.) or continuous detection of one or more biometric characteristics and transmit the biometric characteristics to third-party health server 120. In some embodiments, user device 105 may be operable to transmit a wireless signal to third-party health server 120 via electronic network 115, with the signal being indicative of data including the one or more biometric characteristics. Alert processing server 125 may be configured and operable to train a machine learning model to predict a current state of a user of user device 105 based on a signal received from user device 105, and/or predict an occurrence of an acquisition by the user during the current state. The machine learning model may be further trained to modify a predetermined threshold for defining an influenced state of the user. As used herein, a “machine learning model” may include data (e.g., biometric data, acquisition data, and preprogrammed guidance information data) or instruction(s) for generating, retrieving, and/or analyzing such data. Further, as used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

One or more of user device 105, financial institution server 110, third-party health server 120, and/or alert processing server 125 may communicate with each other over the electronic network 115 in executing the machine learning model to generate an alert with guidance information for delivery to user device 105 to prevent the user from conducting future acquisitions while in a current (influenced) state.

Electronic network 115 may include a telecommunications network such that one or more of user device 105, financial institution server 110, third-party health server 120, and/or alert processing server 125 may communicate with one another over the telecommunications network. The telecommunications network may include, for example, a telephone network, a cellular network, and the like. In other embodiments, electronic network 115 may be a public switched telephone network (PTSN), a voiceover Internet Protocol (VoIP) network, a wide area network (“WAN”), a local area network (“LAN”), personal area network (“PAN”), or the like.

While FIG. 1 depicts the various components of system 100 as physically separate and communicating across network 115, it should be appreciated that in other embodiments one or more components of system 100 may be incorporated partially or completely into any of the other components shown in FIG. 1. In other embodiments, system 100 may include one or more data repositories and/or storage servers in communication with the various components of system 100 via network 115, such as, for example, a health data repository, an acquisition data repository, and more. Some or all of the functionality of the machine learning model may be incorporated into one or more components of system 100, such as, for example, alert processing server 125. Some or all of the functionality of alert processing server 125 may be accessible via user device 105 and incorporated into a mobile internet application, an internet browser extension, or website page.

In some embodiments, one or more components of system 100 (e.g., alert processing server 125) may be configured to generate and/or train a machine learning model to execute one or more processes, such as, for example, process 200 shown and described herein. As described in further detail below, alert processing server 125 may be further configured to train the machine learning model to predict one or more variables in addition to executing the exemplary process 200. The one or more variables may include an occurrence of an acquisition, an influenced state of a user, and more.

Multiple approaches may be used when predicting the user's influenced state and/or occurrence of future acquisitions during the user's influenced state. The machine learning model generated and/or trained by alert processing server 125 may include an automatable, adaptable tool that may provide accurate predictions as to the occurrence of an influenced state and acquisitions during an influenced state. In some embodiments, the model generated and/or trained by alert processing server 125 may include using a “base” or standard machine learning algorithm or technique, and adapting it based on the acquisition data and/or the biometric data received from the one or more components of system 100. In such embodiments, a model including a base machine learning algorithm or technique configured to provide predictions may be trained by alert processing server 125 (e.g., step 220 of process 200). Examples of suitable base machine learning algorithms or techniques include gradient boosting machine (GBM) techniques, or random forest techniques. It should be appreciated that alert processing server 125 may be one or more hardware and/or software components that are configured to sort and analyze the data shown and described herein, generate, train, and/or modify the machine learning model, identify a propensity for a user to be in an influenced state, and predict and analyze the occurrence of acquisitions during a predicted influenced state using the trained machine learning models. In some embodiments, alert processing server 125 may include a plurality of computing devices working in concert to perform data analyses and to predict and evaluate a user's influenced state. Such computing devices may be any suitable computing devices, now-known or later-developed, capable of performing aspects of the processes and methods described herein. Alert processing server 125 may be located in a single geographic area or multiple geographic areas, and may be connected to one another via, e.g., wired or wireless components (e.g., network 115).

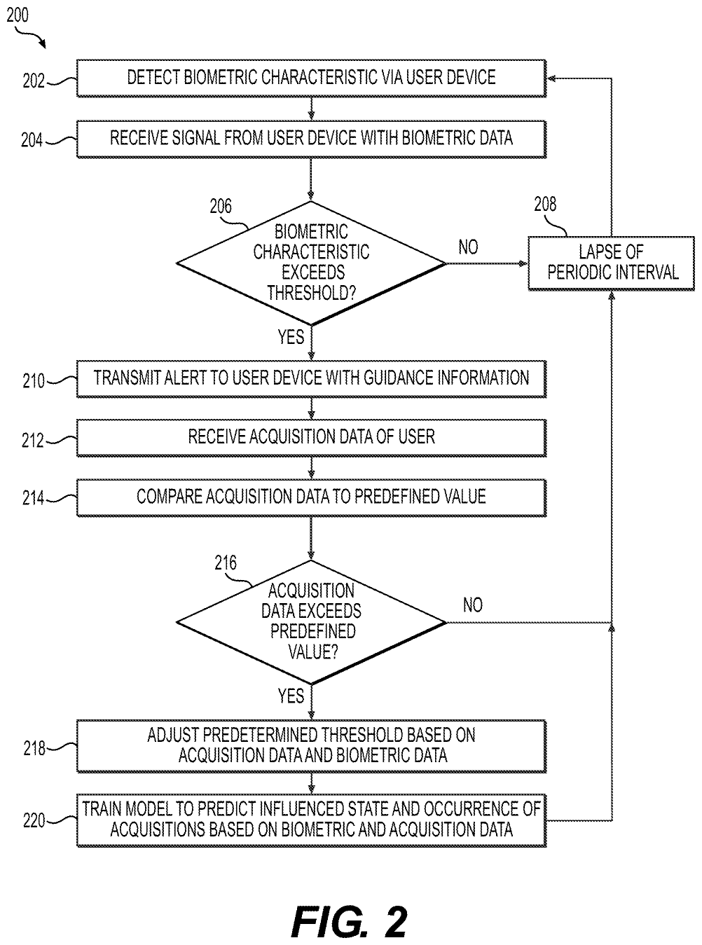

FIG. 2 illustrates an exemplary process 200 for generating an alert with guidance information based on biometric characteristics of a user in accordance with embodiments of the present disclosure. It should be understood that the steps described herein, and the sequence in which they are presented, are merely illustrative such that additional and/or fewer steps may be included without departing from the scope of the present disclosure.

Initially, at step 202, user device 105 may be configured to detect and/or measure one or more biometric characteristics of a user. User device 105 may periodically or continuously detect the biometric characteristics pursuant to programmable settings on user device 105, instructions of a third-party software installed on user device 105, and/or the like. User device 105 may transmit a signal with data (e.g., biometric data) indicative of the one or more biometric characteristics measured by user device 105 to one or more other components of system 100, such as, for example, third-party health server 120. By way of example, the biometric characteristic detected and measured by user device 105 may include a pulse (heart) rate.

At step 204, alert processing server 125 may be configured to receive the signal from user device 105 with the one or more biometric characteristic measurements. In other embodiments, alert processing server 125 may receive the signal from user device 105 via third-party health server 120. In this instance, third-party health server 120 may be operable to forward the signal from user device 105 to alert processing server 125 upon processing the biometric data (e.g., converting raw biometric data to numeric biometric measurements) detected by user device 105. By way of example, third-party health server 120 may associate the biometric data (e.g., pulse rate) from the signal received from user device 105 to a corresponding measurement of approximately 160 beats per minute.

At step 206, alert processing server 125 may be configured to compare the one or more biometric characteristics to a predetermined threshold. The predetermined threshold may correspond to a maximum allowed metric relative to each of the one or more biometric characteristics. Stated differently, the predetermined threshold may define a biometric measurement that corresponds to a user experiencing a current state (e.g., mental, physical, emotional, etc.) that is indicative of an individual with a present propensity to be easily influenced (referred to herein as “influenced state”). In some examples, the current state defined by the predetermined threshold may be associated with an impulsive, rash, shortsighted, hasty, careless, imprudent, and/or spontaneous tendency. It should be appreciated that the predetermined threshold may be preprogrammed and stored on alert processing server 125, and that alert processing server 125 may store at least one predetermined threshold for each type of biometric characteristic measured by user device 105. By way of example, the predetermined threshold may include a pulse rate level of approximately 150 beats per minute.

In some embodiments, the predetermined threshold may be adjustable and personalized for each user of system 100. For example, alert processing server 125 may be configured to determine a predetermined threshold for each type of biometric characteristic based on historical biometric measurement data of each user, as detected by user device 105. It should be appreciated that a maximum allowed metric may vary for each user based on differing physical, mental, and/or emotional traits of the user. For example, the historical biometric measurement data of a first user may indicate a resting pulse rate level that is greater than a resting pulse rate level of a second user. In this instance, a biometric measurement of the second user that may be indicative of an influenced state may not equate to an influenced state for the first user given the varying historical biometric measurement data of the first user. Accordingly, alert processing server 125 may be configured to determine a personalized predetermined threshold for each user of system 100 for use at step 206.

In response to the biometric characteristic not exceeding the predetermined threshold at step 206, system 100 may be configured to wait until a periodic time interval has lapsed at step 208 until redetecting a subsequent biometric characteristic from the user at step 202. The periodic time interval may be defined by one or more of the components of system 100, including but not limited to, user device 105 (e.g., via a third-party health application), alert processing server 125, and more. In response to the biometric characteristic exceeding the predetermined threshold at step 206, system 100 may be configured to determine that the user of user device 105 is in an influenced state.

Still referring to FIG. 2, at step 210, alert processing server 125 may be configured to generate an alert for transmission to user device 105 using the machine learning model. The alert may include various suitable formats, such as, for example, an audible message, a written message, a visual notification, a graphical display, and more. The alert may include guidance information tailored to the user of user device 105, and generally directed at discouraging the occurrence of future acquisitions (e.g., financial purchases) while the user remains in the influenced state. For example, the guidance information included in the alert may be tailored to each user based on one or more parameters, including but not limited to, a user preference, a biometric characteristic measurement relative to the predetermined threshold (e.g., degree of difference), historical acquisition data, and more.

In some embodiments, the guidance information may include one or more communications identifying the influenced state of the user for self-awareness. In this instance, the guidance information in the alert may be directed at encouraging the user to refrain from conducting future acquisitions while in the influenced state. In other embodiments, the guidance information may include prior acquisition metrics (e.g., purchase history data) from when the user was previously in the influenced state. In this instance, the guidance information in the alert may be directed at discouraging the user from conducting future acquisitions by providing historical data of prior transactions of the user. In further embodiments, the guidance information may include an interactive exercise (e.g., a game, a puzzle, a riddle, an article, a meditation activity, a breathing activity, etc.) configured to transition the user from the influenced state to an uninfluenced state. In this instance, the guidance information in the alert may be directed at distracting and/or transitioning the user's current state from the influenced state to the uninfluenced state.

In other embodiments, the alert transmitted to user device 105 may include an inquiry message requiring a responsive input from user device 105 prior to proceeding with an acquisition. In this instance, a pending acquisition being performed by the user may be suspended until an input is received by alert processing server 125 from user device 105. The pending acquisition may be identified by alert processing server 125 upon detecting one or more parameters, such as, for example, operation of one or more software applications or access to one or more internet webpages (e.g., digital retail marketplaces) with user device 105 for performing acquisitions. The pending acquisition may be further identified by detecting entry of a user's financial payment information (e.g., credit card number, bank account number, etc.) into a software application, internet webpage, or merchant computer system, etc. The inquiry message may include the guidance information along with an inquiry confirming whether the user desires to proceed with the pending acquisition in light of the guidance information communicated to the user device in the alert.

Still referring to FIG. 2, at step 212, alert processing server 125 may be configured to retrieve acquisition data of the user while in the influenced state using the machine learning model. For example, the acquisition data may be retrieved from one or more components of system 100, such as financial institution server 110. In the example, the acquisition data may include purchase data received at financial institution server 110 while the user remains in the influenced state. Accordingly, alert processing server 125 may continue to receive acquisition data at step 212 for each purchase and/or transaction conducted by the user (e.g., acquisition) during the influenced state. As described in further detail below, alert processing server 125 may be configured to generate and/or train a machine learning model capable of predicting an occurrence of a future acquisition for when the user is in an influenced state based on prior acquisition data.

At step 214, alert processing server 125 may be configured to compare the acquisition data received at step 212 to a predefined acquisition value using the machine learning model. The predefined acquisition value may define a threshold amount for an acquisition (e.g., a purchase price, a transaction amount, a quantity of transactions, etc.). In some embodiments, the predefined acquisition value may be preprogrammed and fixed, while in other embodiments the predefined acquisition value may be adjustable and personalized for each user of system 100. For example, alert processing server 125 may be configured to determine the predefined acquisition value at least partially based on the prior acquisition data received by alert processing server 125 during periods when the user was previously in the influenced state.

In some embodiments, alert processing server 125 may determine the predefined acquisition value based on a number of acquisitions (e.g., purchases, transactions, etc.) conducted by the user during prior influenced states. In this instance, alert processing server 125 may increase and/or decrease the predefined acquisition value in direct correlation to the number of prior acquisitions conducted by the user in the influenced state. For example, a user conducting multiple acquisitions (e.g., two or more) during prior influenced states may be characterized as having a high propensity for conducting acquisitions while in the influenced state. Accordingly, alert processing server 125 may be configured to decrease the predefined acquisition value for the user such that future acquisitions conducted by the user may be compared to a predefined acquisition value (at step 214) that may be relatively lower than a predefined acquisition value for other users. In other examples, a user conducting minimal acquisitions (e.g., one or less) during prior influenced states may be characterized as having a low propensity for conducting acquisitions while in the influenced state. Accordingly, alert processing server 125 may be configured to increase the predefined acquisition value for the user such that future acquisitions conducted by the user may be compared to a predefined acquisition value (at step 214) that may be relatively greater than a predefined acquisition value for other users.

In other embodiments, alert processing server 125 may determine the predefined acquisition value based on an average acquisition value (e.g., an average purchase price, an average transaction amount, etc.) of acquisitions conducted during prior influenced states. In this instance, alert processing server 125 may increase and/or decrease the predefined acquisition value in direct correlation to an average value of prior acquisitions conducted by the user in the influenced state. For example, a user conducting acquisitions having a high average value during prior influenced states may be characterized as having a high propensity for conducting acquisitions while in the influenced state. Accordingly, alert processing server 125 may be configured to decrease the predefined acquisition value for the user such that future acquisitions conducted by the user may be compared to a predefined acquisition value (at step 214) that may be relatively lower than a predefined acquisition value for other users. In other examples, a user conducting acquisitions having a low average value during prior influenced states may be characterized as having a low propensity for conducting acquisitions while in the influenced state. Accordingly, alert processing server 125 may be configured to increase the predefined acquisition value for the user such that future acquisitions conducted by the user may be compared to a predefined acquisition value (at step 214) that may be relatively greater than a predefined acquisition value for other users.

Still referring to FIG. 2, at step 216, alert processing server 125 may be configured to determine whether the acquisition data received at step 212 exceeds the predefined acquisition value using the machine learning model. In response to determining the acquisition data does not exceed the predefined acquisition value at step 216, system 100 may be configured to wait until a periodic time interval has lapsed at step 208 until redetecting a subsequent biometric characteristic from the user at step 202. In response to determining the acquisition data does exceed the predefined acquisition value at step 216, system 100 may be configured to adjust the predetermined threshold for future use when evaluating a biometric characteristic of user from user device 105.

At step 218, alert processing server 125 may be configured to adjust the predetermined threshold (step 206) based on one or more of the acquisition data (step 212) and the biometric data (step 204) using the machine learning model. For example, the predetermined threshold may be decreased in response to determining a correlation between the acquisition data and the biometric data that indicates the user has a high propensity for conducting multiple acquisitions, and/or acquisitions of greater average value (e.g., via a comparison of the acquisition data to the predefined acquisition value), when in the influenced state. Alert processing server 125 may calculate a quantity of acquisitions occurred during the influenced state, and determine that the quantity (e.g., one acquisition, two acquisitions, three acquisitions, etc.) exceeds a limit when determining to decrease the predetermined threshold. Additionally and/or alternatively, alert processing server 125 may calculate an acquisition value associated with the one or more acquisitions for comparison to the predefined acquisition value, and decrease the predetermined threshold when the acquisition values (e.g., of each, at least one, or a majority of the acquisitions) exceed the predefined acquisition value. Accordingly, alert processing server 125 may decrease the predetermined threshold to establish a lower relative threshold for defining the user's influenced state given the user's high propensity for being influenced.

In other examples, the predetermined threshold may be increased in response to determining a correlation between the acquisition data and the biometric data that indicates the user has a low propensity for conducting acquisitions, and/or acquisitions of greater average value, when in the influenced state. Alert processing server 125 may calculate a quantity of acquisitions occurred during the influenced state and determine that the quantity (e.g., zero acquisitions, one acquisition, two acquisitions, etc.) does not exceed the limit when determining to increase the predetermined threshold. Additionally and/or alternatively, alert processing server 125 may calculate the average acquisition value associated with the acquisition for comparison to the predefined acquisition value, and increase the predetermined threshold when the average acquisition value does not exceed the predefined acquisition value. Accordingly, alert processing server 125 may increase the predetermined threshold to establish a higher threshold for defining the user's influenced state given the user's low propensity for being influenced.

In other embodiments, alert processing server 125 may be configured to maintain the predetermined threshold despite the occurrence of multiple acquisitions during the user's influenced state when the acquisition values of the acquisitions do not exceed the predefined acquisition value. In this instance, alert processing server 125 may disregard the acquisitions occurring in the influenced state upon determining the acquisitions are of an insignificant and/or minimal value relative to the predefined acquisition value. It should be appreciated that alert processing server 125 may be configured to periodically update the predetermined threshold based on the continuous receipt of biometric data (step 204) from user device 105 and/or third-party health server 120 and acquisition data (step 212) from financial institution server 110.

Still referring to FIG. 2, at step 220, alert processing server 125 may be configured to train the machine learning model to predict the user's influenced state based on one or more of the acquisition data (step 212) and the biometric data (step 204). In other embodiments, alert processing server 125 may further train the machine learning model to predict the occurrence of future acquisitions conducted by the user when in the influenced state. For example, alert processing server 125 may analyze one or more acquisitions conducted by the user when in the influenced state and in the uninfluenced state when training the machine learning model to predict the occurrence of future acquisitions. By way of further example, alert processing server 125 may analyze the biometric characteristics of the user, as detected by user device 105, when training the machine learning model to predict the user's influenced and uninfluenced states.

In some embodiments, the machine learning model may be further trained by alert processing server 125 using identifying information of the user received from one or more components of system 100, such as user device 105, financial institution server 110, and/or third-party health server 120. The identifying information may define characteristics of the user, and may be inputted by the user or collected automatically through use of system 100. A user of system 100 may selectively determine one or more settings associated with a use of system 100, such as, for example, settings for collecting the identifying information, biometric data, acquisition data, etc. The user of system 100 may further define one or more settings for when the alert with guidance information is transmitted to user device 105, and may select programmable options for generating routine alerts at periodic intervals (e.g., daily, weekly, monthly, yearly alerts) with selected guidance information (e.g., acquisition data metrics).

By providing live acquisition guidance alerts based on biometric characteristic data measured in real-time, system 100 may preemptively determine a current influenced state of the user to identify the user's momentary propensity for conducting future acquisitions prior to the user's realization of said state. By transmitting guidance alerts to the user with targeted guidance information on conducting future acquisitions during the current influenced state, system 100 may generate and transmit information that varies from a calculation and display of biometric characteristics of the user. Further, system 100 may provide enhanced determination of an influenced state of a user, which may be personalized for each user, based on modified predetermined thresholds and predefined acquisition values. Accordingly, system 100 may generate and/or train a machine learning model capable of providing guidance information at targeted time periods determined by system 100 to be an accurate indication of a user's influenced state. System 100 may minimize occurrences of future acquisitions by users during influenced states, increase a transition of users from an influenced state to an uninfluenced state, and/or proactively reduce processing requirements or constraints on other components of system 100 (e.g., financial institution server 110) as a result of the reduced future acquisitions by users.

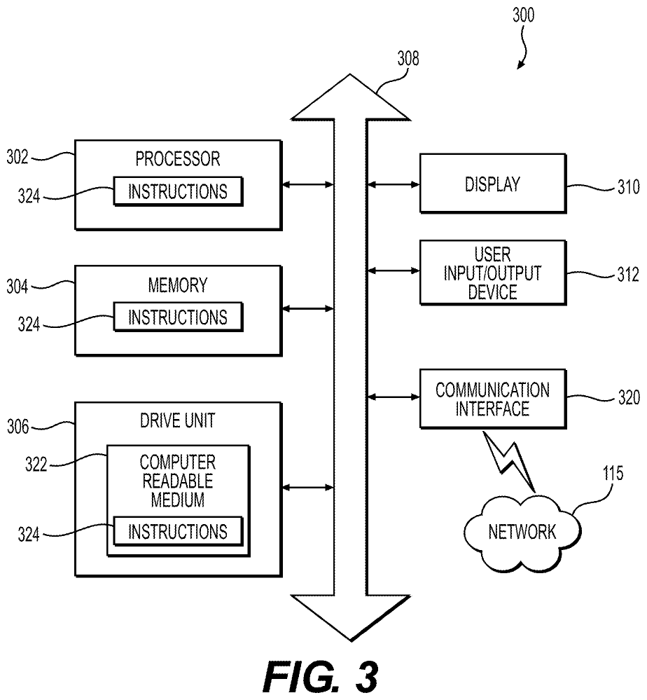

FIG. 3 is a simplified functional block diagram of a computing device 300 that may be configured as a device for executing the methods of FIG. 2, according to exemplary embodiments of the present disclosure. Any of the devices, databases (e.g., servers), processors, etc. of system 100 discussed herein may be an assembly of the hardware of computing device 300 including, for example, user device 105, financial institution server 110, third-party health server 120, and/or alert processing server 125, according to exemplary embodiments of the present disclosure.

Computing device 300 may include a central processing unit (“CPU”) 302 that may be in the form of one or more processors configured to execute program instructions, such as those of process 200 described in detail above. In some embodiments, the processor(s) of CPU 302 includes both a CPU and a GPU. Computing device 300 may further include a storage unit 306 that may include non-volatile memory, such as, for example, a storage media (e.g., solid-state drives), ROM, HDD, SDD, etc. Examples of storage media include solid-state storage media (e.g., solid state drives and/or removable flash memory), optical storage media (e.g., optical discs), and/or magnetic storage media (e.g., hard disk drives). Storage unit 306 may store data on a computer readable medium 322. In some embodiments, computing device 300 may receive programming and data via network communications from electronic network 115, such as, for example, via a communication interface 320 configured to communicate with one or more other components of system 100.

Still referring to FIG. 3, computing device 300 may include a memory 304 that is volatile memory, such as, for example, RAM, solid-state memories, optical storage media (e.g., optical discs), magnetic storage media (e.g., hard disk drives), etc. Memory 304 may be configured for storing one or more instructions 324 for executing techniques presented herein, such as those of process 200 shown and described above. Memory 304 may further include a non-transitory computer-readable medium. Therefore, whenever a computer-implemented method is described in this disclosure, this disclosure shall also be understood as describing a non-transitory computer-readable medium storing instructions that, when executed by one or more processors (e.g., CPU 302), cause the one or more processors to perform the computer-implemented method.

In some embodiments, the one or more instructions 324 may be stored temporarily or permanently within other modules of computing device 300, such as, for example, CPU 302, computer readable medium 322, and more. Computing device 300 may include an input/output device 312 including one or more input ports and one or more output ports. Input/output device 312 may include, for example, a keyboard, a mouse, a touchscreen, etc. (i.e., input ports). Input/output device 312 may further include a monitor, a display, a printer, etc. (i.e. output ports). Computing device 300 may further include a display device 310 configured to connect with input/output device 312. The aforementioned elements of computing device 300 may be connected to one another through an internal communication bus 308, which represents one or more busses.

In other embodiments, the various system functions of process 200 shown in FIG. 2 may be implemented in a distributed fashion on a number of similar platforms to distribute the processing load on multiple computing devices 300. Alternatively, the system functions may be implemented by appropriate programming of one computer hardware platform, such as, for example, computing device 300.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for providing acquisition guidance alerts, the method comprising:
receiving a signal from a user device indicative of a biometric characteristic of a user, wherein the biometric characteristic is detected by the user device;
determining the biometric characteristic exceeds a predetermined threshold, wherein the predetermined threshold defines a first state of the user;
transmitting an alert to the user device with guidance information on conducting future acquisitions during the first state;
receiving acquisition data of the user when the user is in the first state; and
adjusting the predetermined threshold to redefine the first state based on the acquisition data and biometric data received from the user device.

2. (canceled) The computer-implemented method of claim 1, further comprising:
receiving acquisition data of the user when the user is in the first state; and
adjusting the predetermined threshold to redefine the first state based on the acquisition data and biometric data received from the user device.

3. The computer-implemented method of claim 1, wherein adjusting the predetermined threshold comprises:
decreasing the predetermined threshold when the acquisition data indicates an occurrence of one or more acquisitions when the user is in the first state; and
increasing the predetermined threshold when the acquisition data indicates zero occurrences of acquisitions when the user is in the first state.

4. The computer-implemented method of claim 3, wherein prior to decreasing the predetermined threshold, the method comprises:
comparing an acquisition value of the one or more acquisitions, occurring while the user is in the first state, to a predefined value; and
decreasing the predetermined threshold when the acquisition value of at least one of the one or more acquisitions exceeds the predefined value.

5. The computer-implemented method of claim 4, further comprising:
disregarding the one or more acquisitions, occurring while the user is in the first state, when the acquisition value does not exceed the predefined value.

6. The computer-implemented method of claim 4, further comprising:
increasing the predetermined threshold when the acquisition value of each of the one or more acquisitions, occurring while the user is in the first state, does not exceed the predefined value.

7. The computer-implemented method of claim 1, further comprising:
detecting an occurrence of an acquisition by the user; and
transmitting the alert to the user device with the guidance information and an inquiry message, wherein completion of the acquisition is suspended until an input responsive to the inquiry message is received from the user device.

8. The computer-implemented method of claim 1, wherein the biometric characteristic includes a pulse rate, a galvanic skin response, a bodily temperature, a voice cadence, or a facial contour of the user; and
wherein the first state of the user is indicative of an influenced state.

9. The computer-implemented method of claim 1, wherein the guidance information transmitted to the user device comprises a message to refrain from conducting future acquisitions while the user is in the first state.

10. The computer-implemented method of claim 1, wherein the guidance information transmitted to the user device comprises prior acquisition metrics when the user was in the first state.

11. The computer-implemented method of claim 1, wherein the guidance information transmitted to the user device comprises an interactive exercise configured to transition the user from the first state to a second state that is different than the first state.

12. The computer-implemented method of claim 1, further comprising:
using a machine learning model to define the predetermined threshold for a second signal received from the user device, the machine learning model trained to learn associations between signals indicative of a biometric characteristics of users and states of said users.

13. The computer-implemented method of claim 12, further including using the machine learning model to periodically update the predetermined threshold based on acquisition data of the user when the user is in the first state.

14. A computer-implemented method for providing acquisition guidance alerts, the method comprising:
accessing biometric data of a user from a user device, wherein the biometric data is indicative of a current state of the user;
accessing acquisition data of the user from a data repository, wherein the acquisition data corresponds to the current state of the user; and
generating an alert using a the trained machine learning model, the trained machine learning model trained to predict an occurrence of an acquisition by users in a state based on (i) biometric data of said users, and (ii) acquisition data of said users, by:
receiving a signal from the user device indicative of a biometric characteristic of the user;
determining the biometric characteristic correlates to the user conducting future acquisitions during the current state by:
comparing the biometric characteristic to a threshold that defines an influenced state of the user; and
determining the biometric characteristic exceeds the threshold, such that the current state of the user includes the influenced state;
transmitting the alert to the user device with guidance information to prevent the user from conducting the future acquisitions during the current state;
modifying the threshold by:
detecting one or more acquisitions occurring during the influenced state;
determining an acquisition value of one or more acquisitions occurring during the influenced state; and
comparing the acquisition value to a predefined value.

15. (canceled)

16. (canceled)

17. (canceled)

18. The computer-implemented method of claim 14, further comprising modifying the threshold by:
decreasing the threshold in response to the acquisition value of at least one of the one or more acquisitions exceeding the predefined value; and
increasing the threshold in response to the acquisition value of each of the one or more acquisitions not exceeding the predefined value.

19. The computer-implemented method of claim 14, wherein the biometric characteristic includes a pulse rate, a galvanic skin response, a bodily temperature, a voice cadence, or a facial contour of the user.

20. A system for facilitating transmission of guidance alerts, comprising:
a processor; and
a memory storing instructions that, when executed by the processor, causes the processor to perform operations including:
receiving a signal from a user device indicative of a biometric characteristic of a user, wherein the biometric characteristic is detected and measured by the user device;
determining the biometric characteristic exceeds a predetermined threshold, wherein the predetermined threshold defines an impulsive state of the user;
transmitting an alert to the user device with guidance information for the user on conducting future acquisitions during the impulsive state;
receiving acquisition data of the user when the user is in the impulsive state; and
adjusting the predetermined threshold to redefine the impulsive state based on the acquisition data and biometric data received from the user device.
